(19) United States
(12) Patent Application Publication
(10) Pub. No.: US 2017/0311117 A1
(43) Pub. Date: Oct. 26, 2017

(54) REMOTELY ACCESSIBLE PERSONAL DIGITAL DRIVE AND SYSTEM

(71) Applicant: Omar Rivas, Orlando, FL (US)

(72) Inventor: Omar Rivas, Orlando, FL (US)

(21) Appl. No.: 15/136,300

(22) Filed: Apr. 22, 2016

(51) Int. Cl. H04W 4/00; G06F 13/42; G06F 1/16; G06F 21/32; G06F 21/86

(52) U.S. Cl. CPC H04W 4/008; G06F 21/32; G06F 21/86; G06F 1/1656; G06F 13/4282; G06F 2221/2143

(57) ABSTRACT

A remotely accessible personal digital drive device and system includes a sleek and resilient main body having a shape and thickness that approximates a credit card. A memory is positioned within the main body and is arranged to store operating instructions and user-supplied information. A communication unit is positioned within the main body and communicates with a smartphone running a personal drive app. An RFID chip and antenna are embedded within the drive and are controlled by the smartphone app. A touch sensitive display screen is provided on the main body to scan and store fingerprint identification directly on the drive.

### TECHNICAL FIELD

The present invention relates generally to data storage devices, and more particularly to a remotely accessible personal digital drive.

### BACKGROUND

The statements in this section merely provide background information related to the present disclosure and may not constitute prior art.

As technology continues to become a greater part of everyday life, it is becoming increasingly necessary for people to store selected files in multiple locations for easy access. For example, users may store their music on multiple devices such as their home computer, their MP3 player and/or their smartphones, in order to have the same available when utilizing a home theatre, working out at the gym, and/or for connecting to their car radio, respectively.

Likewise, many people routinely need to access personal or work files at locations other than the office. As such, it is not uncommon for individuals to copy work documents and other such files onto a storage device, such as a USB drive, for example, in order to allow them to access the files on their home computer or on the go via a laptop computer. Although such actions provide a quick means for accessing the files, little thought is often given to security, particularly if the documents contain sensitive or personal information, as it can become difficult to ensure that the data has been fully erased from each device onto which it was copied. Moreover, even when the data is not secretive in nature, the creation and storage of multiple copies on various computers eventually fills the storage capacity of the devices, thereby degrading system performance.

In addition to the above, recent advancements in technology have seen an influx of digital payment methods wherein users can pay for goods and services utilizing electronic devices, such as their smartphone, for example. In this regard, the majority of these systems require the user to enter their credit card details into the memory of their smartphone device for use by the electronic payment application. Unfortunately, when the user eventually upgrades to another phone and/or loses their phone, the payment information stored within the phone memory may fall into the hands of thieves.

Accordingly, it would be beneficial to provide a personal storage drive having a small size that can be unobtrusively carried by a user at all times, in order to store digital files that can be securely and remotely accessed by a user, without suffering from the drawbacks of the above noted devices.

### SUMMARY OF THE INVENTION

The present invention is directed to a remotely accessible personal digital drive device and system. One embodiment of the device can include a sleek and resilient main body having a shape and thickness that approximates a credit card, a memory that is positioned within the main body and is arranged to store operating instructions and user-supplied information, and a communication unit that sends and receives information wirelessly. An input output unit is provided and can include a touch sensitive display screen for performing two way communication with a device user. The device can also utilize the touch screen to scan and store fingerprint identification from a user, and to verify the user identity via the same upon subsequent requests for accessing the device memory.

In another embodiment, the device can be communicatively paired with an external device such as a smartphone, running an application for providing users with remote access to the device memory. The app can include functionality for verifying the fingerprint information utilizing the smartphone screen. In yet another embodiment, an RFID chip and antenna can be embedded within the drive, and can be controlled by the smartphone via the drive app.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 illustrates one embodiment of a remotely accessible personal digital drive system that is useful for understanding the inventive concepts disclosed herein.

FIG. 2 is perspective view of the remotely accessible personal digital drive device, in accordance with one embodiment of the invention.

FIG. 3 is a simplistic block diagram of the controller of the remotely accessible personal digital drive device, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

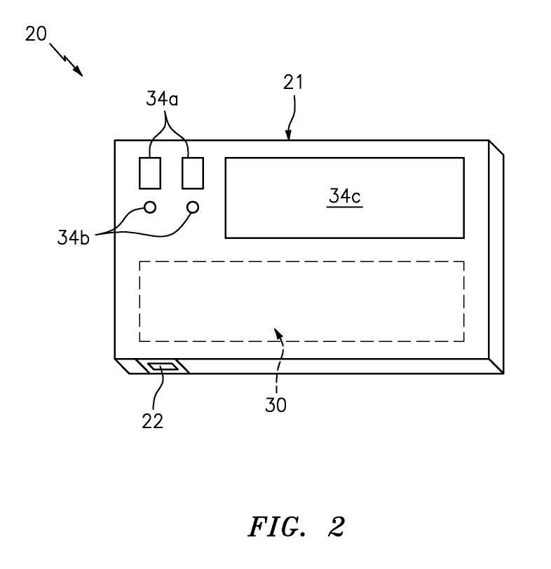

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

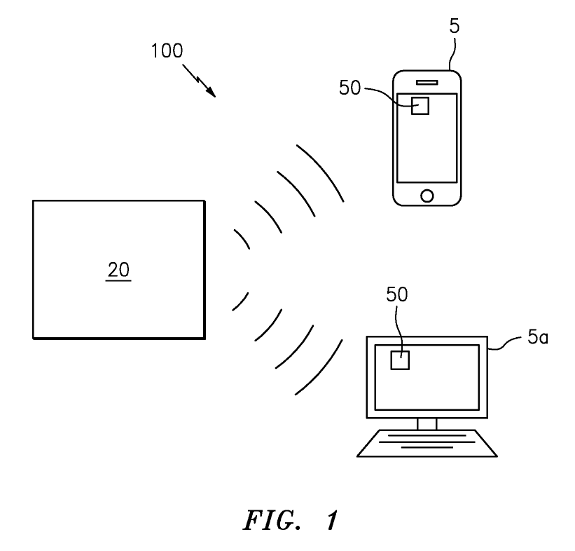

FIG. 1 illustrates one embodiment of a remotely accessible personal digital drive system 100 that is useful for understanding the inventive concepts disclosed herein. As shown, the system 100 can include a remotely accessible personal digital drive 20 that can be wirelessly connected to a remote device 5 running a personal drive application 50.

The remotely accessible personal digital drive 20 can function to allow a user to quickly and securely access digital information utilizing a remote device such as a smartphone or computer, for example. As will be described below, the remote device can include an application for securely accessing the personal drive files without copying any of the information onto the remote device itself.

In the below described examples, programming code for allowing the remote device to securely access the contents of the digital drive can be presented in the form of a smartphone mobile application (i.e., App) which can be preloaded on a smartphone device, or downloaded and installed as an application after purchase of the smartphone device. Of course, the inventive concepts disclosed herein are not to be construed as limiting to a smartphone App, as virtually any type of instruction sets, in any form of programming language that can be executed on any type of processor enabled device are also contemplated.

Although described with respect to a smartphone device, this is for illustrative purposes to show the best mode of the device. However, it is to be expressly understood that the remotely accessible personal digital drive 20 can be used with any type of processor enabled device that is capable of providing two way communication with a secondary device and/or a human operator. Several nonlimiting examples include computers 5a such as tablet, laptop and desktop computers, along with PDAs, portable music devices (MP3 players), and/or wearable devices such as smartphone watches, for example. Accordingly, the device and/or method steps are not to be construed as limiting in any manner.

In either instance, processor enabled devices such as those described above generally include installed software adapted to generate one or more program icons, such as a personal drive icon 50, and to display same on the display screen of the device. The icon can be launched via an actuating means such as a touch sensitive screen, and/or a keyboard and mouse, for example. Selecting the personal drive icon instructs the device to establish communication with the drive 20.

As shown in FIG. 2, the remotely accessible personal digital drive 20 can include a sleek, compact and generally resilient main body 21 having the shape and approximate thickness of a conventional credit card, so as to be able to be carried in the wallet of a user and to withstand the rigors of such. The main body can preferably be constructed from durable plastic forming a watertight environment for housing the internal controller. In the preferred embodiment, the main body can incorporate various tamperproof systems wherein the below described memory 32 is destroyed if the main body is breached (e.g., opened or cut in any way). For example, an acid membrane can be secured between the memory and the main body that releases the acid content into the memory in the event the main body is severely bent, cracked, cut or opened.

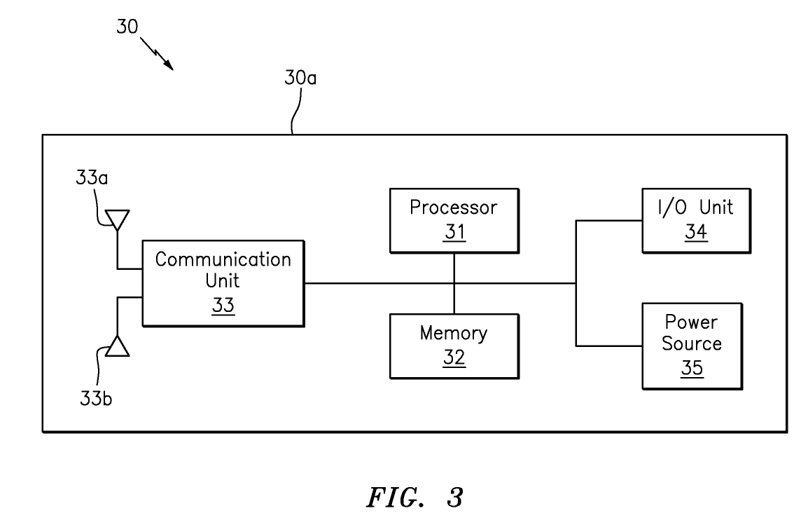

As shown in FIG. 3, the digital drive can include an internal controller for performing the device operation. The controller 30 can include a processor 31 that is conventionally connected to an internal memory 32, a communication unit 33, an input/output unit 34, and a power source 35.

Although illustrated as separate elements, those of skill in the art will recognize that one or more system components may be, or may include, one or more printed circuit boards (PCB) 30a, containing an integrated circuit or circuits for completing the activities described herein, and the CPU may be one or more integrated circuits having firmware for causing the circuitry to complete the activities described herein. Additionally, one or more of the controller elements may also be arranged as a completely separate element (such as the power source and/or the inductor, for example) that is/are communicatively linked to the processor.

The processor/CPU 31 can act to execute program code stored in the memory 32 in order to allow the device to perform the functionality described herein. Processors are extremely well known in the art, therefore no further description will be provided.

Memory 32 can act to store operating instructions in the form of program code for the processor 31 to execute. Although illustrated in FIG. 3 as a single component, memory 32 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device, and most preferably a solid state hard drive. Additionally, memory 32 can also include one or more cache memories that provide temporary storage of at least some program code in order to reduce the number of times program code must be retrieved from the bulk storage device during execution. Each of these devices are well known in the art.

The communication unit 33 can include any number of devices capable of communicating with a smartphone or other externally located processor enabled device. In one preferred embodiment, the communication unit can include a wireless communication module such as a Bluetooth transceiver 33a, for example, that communicates wirelessly with a smartphone running the personal drive App 50. However, any number of other known transmission and reception mechanisms and/or communication protocols are also contemplated. Several additional nonlimiting examples include unique radio frequency transmitter and receivers, infrared (IR) transceivers, and/or a network adapter functioning to communicate over a WAN, LAN or the internet, for example. In addition to the above, the communication unit can also include an RFID chip and transmitter 33b, which can interface with a user's credit card information that can be stored within the memory 32, in order to perform wireless payments.

Although described above as performing wireless communication, other embodiments are also contemplated. In this regard, the communication unit can include, or can interface with, any number of physical communication ports capable of sending and receiving information with a smartphone. Several nonlimiting examples include the illustrated micro USB connector 22, along with other types of ports, cables, and devices.

The input/output unit 34 can function to send and receive information between the processor 31, a remote device 5 and/or a user. In various embodiments, the input/output unit can include or control one or more buttons/switches 34a, and/or lights 34b, for example that are connected to the processor 31 so as to activate or confirm various programmatic functions. In one embodiment, the input/output unit can include or control a touch sensitive display screen such as a Graphic User Interface (GUI) 34c, for example, that is capable of performing two way communication with a device user.

Several nonlimiting examples of functionality which can be performed by the input/output unit includes the ability to switch the device between an ON and OFF operating state, initiate a sleep mode, pair the communication unit 33 with a smartphone or other such device and/or to confirm the user identity via fingerprint or retina scans, as described below.

The power source 35 can include one or more coin cell batteries that are capable of providing the necessary power requirements to each element of the device 20. In one embodiment, the battery or batteries can be accessible via a removable battery cover (not illustrated), in order to allow a user to easily access and replace the batteries when they are depleted. Of course, the invention is not limited to such a feature, as other embodiments are contemplated wherein one or more batteries are permanently located within the main body and/or can be rechargeable in nature via the USB port 22, for example.

In operation, the remotely accessible personal digital drive 20 can securely send and receive information wirelessly with any number of external devices. Before any such communication can begin, the drive can require the user to establish a security identifier such as a password and/or a biometric information when initially setting up the drive.

In one embodiment, the user can be required to establish a biometric identifier when initially configuring the drive 20. Such a feature can be performed utilizing the input/output unit 34, wherein the touchscreen 34c, or fingerprint scanner if provided, records the fingerprint of the device owner and stores the recorded image within the device memory 32. As such, once a sample print has been stored, the drive can confirm the user identity going forward, as needed.

Once the drive has been initially configured and the security identifiers have been established on the physical drive, the user can then be allowed to establish a communicative link between the drive 20 and an external device such as a smartphone 5, containing the above described application 50.

In one embodiment, the application 50 can include functionality for accessing the smartphones' touchscreen and/or camera to scan the user fingerprint and compare the scanned image with that stored in the physical drive. Upon verification, the application 50 can open a browser window thereby allowing the user to deposit, remove and/or edit the files within the drive memory 32.

In yet another embodiment, the application 50 can include functionality for performing iris or retina verification. In such an example, the application can access the camera of the smartphone device 5 to capture an image of the users' eye that is then stored in the memory of the card 32. Such a feature can provide a second layer of security moving forward when attempting to access the drive files.

In either instance, once the drive 20 and the device 5 having the App 50 have been communicatively linked (e.g., Bluetooth or other such connection), a user can utilize the device 5 to access the drive memory 32, in order to deposit files, edit files and perform other such actions, without requiring the files to be physically copied onto the device 5 memory. Once the user has finished accessing the files he or she can log out of the App 50, thereby closing the connection between the drive 20 and the device 5.

In addition to the above described functionality, the device 5 running the App 50 can be utilized with various types of wireless payment systems. In this regard, upon establishing communication with the drive 20, as described above, the App can instruct the RFID chip and antenna 33b within the drive to initiate wireless payment at a compatible terminal. Such a feature eliminates the need for the user to physically access the drive 20 and/or a particular credit card when checking out. Of course, the App 50 can also utilize the smartphones communication unit to transmit the credit card information that is stored in the device memory 32.

Although described above with respect to particular steps, features and/or uses, these examples are provided merely to illustrate some of the functionality of the remotely accessible personal digital drive. As such, many modifications and/or other uses are also contemplated.

As to a further description of the manner and use of the present invention, the same should be apparent from the above description. Accordingly, no further discussion relating to the manner of usage and operation will be provided.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

Various portions of the program code may execute entirely on the user's smartphone, partly on the user's smartphone, as a stand-alone software package, partly on the remote drive, or entirely on the remote drive.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A remotely accessible personal digital drive device, comprising:
a solid state memory that is configured to store operating instructions and user information;
a communication unit that is configured to perform wireless communication with an external device;
an input output unit configured to receive operating instructions;
a processor that is in communication with each of the memory, the input unit and the communication unit; and
a weatherproof main body for securely positioning each of the processor, the memory, the input unit and the communication unit, said main body including a shape and thickness that approximates a shape and thickness of a credit card.

2. The device of claim 1, further comprising:
a touch sensitive display screen that is positioned along the main body and communicatively linked to the input output unit.

3. The device of claim 2, wherein the processor is configured to instruct the touch sensitive display to scan a users' fingerprint, and to store the scanned image within the device memory.

4. The device of claim 1, further comprising:
an RFID chip and transmitter that are embedded within the main body, and accessible via the processor.

5. The device of claim 1, further comprising:
a battery operated power source that is positioned within the main body.

6. The device of claim 5, further comprising:
a micro USB port that is secured along the main body, said port functioning to send and receive information with an external device via a communication cable.

7. The device of claim 6, wherein the micro USB port is further configured to recharge the battery operated power source.

8. The device of claim 1, wherein the input output unit is communicative linked to at least one push button and one light that are positioned along the main body.

9. The device of claim 1, wherein the main body is constructed from a compact and generally resilient material.

10. The device of claim 1, further comprising:
a tamper proof layer that is disposed along an inside portion of the main body, said tamperproof layer functioning to destroy the device memory if the main body becomes breached.

11. The device of claim 1, wherein the communication unit comprises:
a Bluetooth transceiver.

12. A remotely accessible personal digital drive system, said system comprising:
a personal digital drive device that includes:
a solid state memory that is configured to store operating instructions and user information,
a communication unit that is configured to perform wireless communication,
an input output unit configured to receive operating instructions,
a processor that is in communication with each of the memory, the input unit and the communication unit, and
a weatherproof main body for securely positioning each of the processor, the memory, the input unit and the communication unit, said main body including a shape and thickness that approximates a shape and thickness of a credit card; and
a personal drive application that includes machine readable instructions for execution on a smartphone device having a display screen, said application functioning to
communicate wirelessly with the communication unit of the personal digital drive device, and
generate an interface on the smartphone display screen for navigating and accessing the solid state memory of the digital drive device.

13. The system of claim 1, further comprising:
a touch sensitive display screen that is positioned along the main body of the device, and communicatively linked to the input output unit.

14. The system of claim 13, wherein the processor is configured to instruct the touch sensitive display to scan a users' fingerprint, and to store the scanned image within the device memory.

15. The system of claim 12, further comprising:
an RFID chip and transmitter that are embedded within the main body of the device.

16. The system of claim 15, wherein the personal drive application includes functionality for activating the RFID chip and transmitter via the smartphone display screen.

17. The system of claim 12, further comprising:
a battery operated power source that is positioned within the main body.

18. The system of claim 17, further comprising:
a micro USB port that is in communication with the processor and is further configured to recharge the battery operated power source.

19. The system of claim 12, further comprising:
a tamper proof layer that is disposed along an inside portion of the main body, said tamperproof layer functioning to destroy the device memory if the main body becomes breached.

20. The system of claim 12, wherein the communication unit comprises:
a Bluetooth transceiver.
